(19) United States
(12) Patent Application Publication
(10) Pub. No.: US 2026/0116339 A1
(43) Pub. Date: Apr. 30, 2026

(54) METHOD FOR OPERATING AN ANTI-THEFT ALARM SYSTEM FOR A VEHICLE

(71) Applicant: HELLA GMBH & CO. KGAA, Lippstadt (DE)

(72) Inventors: Roman Curkin, Lippstadt (DE); Oliver Kirsch, Wuppertal (DE); Ludger Weghaus, Lippstadt (DE)

(21) Appl. No.: 19/372,528

(22) Filed: Oct. 29, 2025

(30) Foreign Application Priority Data
Oct. 31, 2024 (DE) 102024131903.8

(51) Int. Cl. B60R 25/104; B60R 25/10

(52) U.S. Cl. CPC B60R 25/104; B60R 25/1004

(57) ABSTRACT

The invention relates to a method for operating an anti-theft alarm system for a vehicle. The vehicle includes a sensor device for monitoring a vehicle interior and an alarm means. The method includes: transmission of an electromagnetic output signal by the sensor device; reception of an impulse response to the output signal by the sensor device, wherein the impulse response includes a plurality of runtime components, wherein each runtime component is characteristic of a specific signal runtime; comparison of the impulse response with a reference impulse response and determination of changes of the runtime components relative to the reference impulse response; determination of a change value as a function of the changes in at least a portion of the runtime components by aggregating the changes in at least a portion of the runtime components; and activation of the alarm means when the change value reaches a predetermined reference value.

### CROSS-REFERENCE TO RELATED APPLICATIONS

The present application claims the benefit of German Patent Application DE 10-2024-131-903.8, filed Oct. 31, 2024, the disclosure of which is incorporated by reference.

### FIELD OF THE INVENTION

The invention relates to a method for operating an anti-theft alarm system for a vehicle, an anti-theft alarm system for a vehicle, a vehicle with an anti-theft alarm system, a computer program product, a computer-readable storage medium, as well as a data carrier signal.

### BACKGROUND OF THE INVENTION

It is known that anti-theft alarm systems are used in vehicles. These monitor the interior of the vehicle when it is parked or alternatively stopped and detect unauthorized access to the vehicle interior or alternatively trigger an alarm in this case. Anti-theft alarm systems typically use ultrasonic sensors, which are provided solely for monitoring the vehicle interior and are not used for other vehicle functions. The integration of such an anti-theft alarm system into a vehicle is disadvantageous in terms of the manufacturing costs of the vehicle. With regard to anti-theft alarm systems, it is also known that they can tend to trigger false alarms, which limits the ease of use of the vehicle.

### SUMMARY OF THE INVENTION

It is therefore one task of the present invention to at least partially overcome at least one of the aforementioned disadvantages. In particular, the task of the invention is to provide a method for operating an anti-theft alarm system for a vehicle, an anti-theft alarm system for a vehicle, a vehicle with an anti-theft alarm system, a computer program product, a computer-readable storage medium, as well as a data carrier signal, which enable the more cost-effective implementation of an anti-theft alarm system in a vehicle, and/or to efficiently avoid false alarms of an anti-theft alarm system.

The above task is solved by a method for operating an anti-theft alarm system for a vehicle according to a first aspect of the present invention, by an anti-theft alarm system for a vehicle according to a second aspect of the present invention, by a vehicle with an anti-theft alarm system according to a third aspect of the present invention, by a computer program product according to a fourth aspect of the present invention, by a computer-readable storage medium according to a fifth aspect of the present invention, as well as by a data carrier signal according to a sixth aspect of the present invention. Further features and details of the invention are apparent from the subclaims, the description, and the drawings. Features and details described in connection with the carrier module according to the invention also apply, of course, in connection with the carrier device according to the invention and/or in connection with the carrier system according to the invention and/or in connection with the method according to the invention, and vice versa, so that mutual reference is or alternatively can be made to the disclosure of the individual aspects of the invention.

According to a first aspect, the present invention relates to a method for operating an anti-theft alarm system for a vehicle, comprising at least one sensor device for monitoring a vehicle interior of the vehicle as well as at least one alarm, wherein the method comprises: transmission of an electromagnetic output signal by the sensor device; reception of an impulse response to the output signal by the sensor device, wherein the impulse response comprises a plurality of runtime components, wherein each runtime component is characteristic of a specific signal runtime; comparison of the impulse response with a reference impulse response and determination of changes in the runtime components relative to the reference impulse response, in particular by the sensor device and/or a control unit; determination of a change value as a function of the changes in at least a portion of the runtime components, in particular by aggregating the changes in at least a portion of the runtime components, in particular by the sensor device and/or a control unit; and activation of at least one alarm when the change value reaches or exceeds a predetermined change reference value, in particular by the sensor device and/or a control unit.

It can be provided in the context of the invention that the method is a computer-implemented method. In addition or alternatively, it is conceivable that at least individual steps of the method, at least in part, run simultaneously or that the steps of the method are carried out in the specified order. In addition or alternatively, at least individual steps of the method or all steps of the method may be performed in a recurring manner. In particular, each transmission of an electromagnetic output signal may initiate a renewed execution of the entire method.

In other words, the present invention proposes a method for operating an anti-theft alarm system, wherein the anti-theft alarm system comprises at least one sensor device for monitoring a vehicle interior of the vehicle.

According to the invention, it is provided that an electromagnetic output signal is put out by the sensor device. This output signal is reflected, at least in part, by objects in the interior of the vehicle or in the external vehicle environment. The reflected signals are received by the sensor device as an impulse response to the output signal.

In so doing, the channel impulse response (CIR) comprises a plurality of runtime components (taps). The runtime components should be understood as signal components of the impulse response that were received in time-delayed manner by the sensor device. This time delay results in particular from the sampling rate at which incoming signals, especially wave signals, are sampled by the sensor device. Different runtime components correspond, for example, to reflections of the output signal from objects that are at different distances from the sensor device. Each of the runtime components is therefore specific to a signal runtime. Assuming that the electromagnetic output signal propagates at the speed of light, each signal runtime or alternatively runtime component is also characteristic of a distance between the sensor device and the object that reflected the output signal.

It is, moreover, provided according to the invention that, in particular by means of the sensor device and/or a control unit, the impulse response is compared with a reference impulse response and changes in the impulse response, in particular changes in the amplitude of the impulse response, relative to the reference impulse response, in particular relative to the amplitude of the reference impulse response, are determined for the respective runtime components. The reference impulse response characterizes a reference state in which there is no unauthorized access to the vehicle interior. Deviations of the impulse response from the reference impulse response allow the conclusion to be drawn that an unauthorized access to the vehicle is taking place. In so doing, the changes are preferably determined specifically for each runtime component.

A reference impulse response can, for example, be predetermined for a specific vehicle or alternatively a specific sensor device, in particular at the factory, or alternatively be stored in a data memory of the sensor device and/or a control unit. A reference impulse response can comprise a number of runtime components corresponding to the impulse response, each of which is characteristic of the same signal runtimes of the runtime components of the impulse response.

It is, moreover, provided that, in particular by means of the sensor device and/or a control unit, a change value is determined as a function of the changes of at least a portion of the respective runtime components, in particular all of them, in particular those comprised by the impulse response. In particular, the changes of all runtime components or only a portion of the runtime components can be used for this purpose. Preferably, for this purpose, the changes of the individual runtime components can be aggregated to form a change value or alternatively total change value.

It is, moreover, provided that the determined change value is compared with a predetermined change reference value and at least one alarm means is activated when the change value reaches or exceeds the change reference value. In other words, an alarm means is activated when the change in the impulse response reaches or alternatively exceeds a predefined limit value (change reference value).

In the context of the invention, it may be provided that the at least one alarm means is only activated when the change value reaches or exceeds the change reference value in at least two, in particular chronologically successive, received impulse responses. In other words, it may be provided that the method is performed with respect to several chronologically successive impulse responses and that the at least one alarm means is only activated when the change value reaches or exceeds the change limit value in a plurality of impulse responses, in particular at least two or at least four or at least 10. In so doing, the mechanisms described in the context of the invention may preferably be applied with regard to the processing of each impulse response.

The method according to the invention provides that at least one electromagnetic sensor is used for interior monitoring. In contrast to the use of ultrasonic sensors, this enables the sensor devices required for the anti-theft alarm system to also be used for other vehicle systems, such as, in particular, systems for access control or alternatively usage control in the vehicle. The number of sensors that are to be provided in a vehicle can hereby be reduced and a simpler and more cost-effective vehicle design can be realized. In the context of the method, it is, moreover, provided that a triggering of the alarm only occurs when the change value exceeds a predetermined limit value, whereby the triggering of false alarms can be prevented.

In particular, at least one sensor device can be configured to transmit an electromagnetic output signal and to receive an impulse response to the output signal.

Changes in runtime components can preferably be considered in terms of magnitude in order to detect signal changes regardless of their direction.

In the context of the present invention, it may preferably be provided that the method moreover comprises the following: provision of at least one change signal of a runtime component, in particular by aggregating the changes of the runtime components determined for a plurality of chronologically successively received impulse responses, wherein the change signal characterizes a temporal course of the changes of the runtime component, in particular by a control unit and/or the sensor device; performance of a pattern recognition for at least one reference frequency in the at least one change signal for the detection of frequency components in the at least one change signal that correspond to the reference frequency, and provision of a recognition result; and adjustment of an operation, in particular a sensitivity, of the anti-theft alarm system as a function of the recognition result, in particular by the sensor device and/or a control unit.

In particular, it may be provided that a change signal is made available for a plurality of runtime components, preferably for all runtime components, and that a pattern recognition is performed for a plurality of change signals, preferably for all change signals. In addition or alternatively, a reference frequency or a plurality of reference frequencies may be taken into account in the context of pattern recognition.

The data required for one or more change signals may preferably be stored in a data memory of the sensor device and/or at least one control unit. In this way, for example, the impulse responses received by the sensor device and/or the changes determined for the runtime components for each impulse response can be stored in the data storage device so that a temporal history of a runtime component or a change signal of this runtime component can be provided by retrieving or evaluating this data.

At least one change signal can, for example, be characteristic of a temporal course of a runtime component over a time period between 5 seconds and 60 seconds, preferably between 10 seconds and 40 seconds, and particularly preferably between 20 seconds and 30 seconds. Such a time period has proven to be advantageous with reference to a reliable recognition of vehicle-imparted movement of interfering objects in the vehicle interior

The recognition result is preferably characteristic of whether and/or in which change signals at least one frequency component corresponding to a reference frequency was detected and/or which frequency components these are. In the context of this invention, a positive recognition result should be characteristic of at least one frequency component corresponding to a reference frequency being detected in at least one change signal. A negative recognition result, on the other hand, should be characteristic of the fact that no such frequency component was detected in any change signal.

In the context of the invention, it was recognized that movements of the vehicle can be transferred to objects in the interior. If these objects do not include inert media (for example, liquids, metallic or metallized objects), movement of these objects in the vehicle interior can trigger significant changes in runtime components of impulse responses received by a sensor device. This can trigger false alarms in the anti-theft alarm system.

Since the anti-theft alarm system is active when the vehicle is parked or the vehicle interior is unoccupied, any movement of these objects is always imparted by movement of the vehicle. This can be, for example, a vibrating movement imparted directly on the vehicle from outside or an indirect movement of the vehicle due to external influences, for example, on a ferry or a train. The performance of a pattern recognition in one or a plurality of change signals makes it possible to recognize a movement imparted by the vehicle on interference objects located in the vehicle interior as such and to adjust the operation of the anti-theft alarm system in such a way that false alarms are avoided.

Preferably, it can be provided that the provision of at least one change signal of a runtime component takes place by aggregating the changes in the runtime component determined for a plurality of chronologically successively received impulse responses. In other words, a temporal history of the changes of the relevant runtime component is created over a plurality of chronologically successively received impulse responses. The resulting change signal is a course of the changes in the respective runtime component over time, with each point in time representing a specific impulse response.

In particular, it may be provided that, in the event of a positive recognition result, an operation of the anti-theft alarm system is adjusted in such a way that the sensitivity of the anti-theft alarm system is reduced. In particular, reducing sensitivity in this case is to be understood as an adjustment of the anti-theft alarm system in such a way that, in order for an alarm to be triggered, stronger activity must be detected in the vehicle interior or alternatively stronger changes in the impulse responses are required and/or that the movement of interfering objects in the vehicle interior imparted by the vehicle is not taken into account, or is only taken into account to a lesser extent, when deciding whether or not to trigger an alarm.

With reference to the present invention, it may preferably be provided that at least one reference frequency is a natural frequency of the vehicle. In particular, the natural frequency may be a natural frequency of a mass-spring system of the vehicle. If an oscillation is introduced into a vehicle from outside, for example, by human force, the vehicle thereby oscillates at the natural frequency of the mass-spring system of the vehicle. Accordingly, a natural frequency of the vehicle or alternatively of its mass-spring system is the oscillation frequency that is also transferred to objects or alternatively interfering objects in the vehicle interior. Taking the natural frequency of the vehicle into account as a reference frequency has proven to be particularly advantageous in this respect.

In addition or alternatively, it may be provided that at least one reference frequency is an external frequency imparted on the vehicle, in particular indirectly. This means that it is not a direct movement of the vehicle, but rather a movement of a vehicle environment in which the vehicle is arranged in such a way that it moves with the vehicle environment. Accordingly, these movements are also transferred to objects in the vehicle interior. An example of this is the transport of a vehicle on a ferry or alternatively on a ship, whereby the swaying of the ship is transferred to the vehicle.

Within the scope of the present invention, it can preferably be provided that the provision of the at least one change signal and/or the performance of the pattern recognition only occurs when the change limit value reaches or exceeds a predetermined activation value. In other words, it is conceivable that the change limit value is compared with a predetermined threshold value (activation value). If the change value reaches or exceeds the threshold value, then the provision of at least one change signal or alternatively a pattern recognition is performed.

If, on the other hand, the activation value is not reached, then preferably neither the provision of at least one change signal nor pattern recognition is performed. Such an approach offers the advantage that the computing power required to generate at least one change signal or to perform pattern recognition is only called upon when there is justified suspicion of unauthorized access to the vehicle. A more energy-efficient and battery-saving operation of the vehicle is hereby achieved.

The activation value may preferably be lower than the change reference value or alternatively represent an alarm threshold that is subordinate to the change reference value.

It may be provided in the context of the invention that the provision of the at least one change signal and/or the performance of pattern recognition is only performed when the change value reaches or exceeds the activation value in at least two, in particular chronologically successive, reception impulse responses. In other words, it may be provided that the method is performed with reference to several chronologically successive impulse responses and that the provision of the at least one change signal and/or the performance of pattern recognition only takes place if, in a plurality, in particular at least two, or at least four, or at least 10, impulse responses, the change value respectively reaches or exceeds the activation value.

It can be advantageous if the determination of the change value and the comparison of the change value with the activation value are performed by the sensor device. In addition or alternatively, it can be provided that the provision of at least one change signal takes place by means of the sensor device. It has also proven advantageous if the pattern recognition is performed by a control unit of the anti-theft alarm system or alternatively by the vehicle. For this purpose, the change signals provided by the sensor device can be transferred from the sensor device to the control unit via a communication link, for example, a CAN bus. The computing power required for this can thus be provided centrally. Such an approach has proven to be advantageous with reference to an energy-efficient and battery-saving operation of the anti-theft alarm system.

With reference to the present invention, it may also be provided that, when the change value repeatedly exceeds the activation value with reference to a plurality of chronologically successively received impulse responses, the performance of a pattern recognition and/or the adjustment of the operation of the anti-theft alarm system is suspended, at least temporarily, in particular for a predetermined period of time. A reduced sensitivity of the anti-theft alarm system is then maintained over this predetermined period of time, and further pattern recognitions are not performed in order to achieve battery-saving or energy-efficient operation of the anti-theft alarm system. Such an approach offers advantages, for example, when a vehicle is parked on a busy road and is repeatedly set in motion by passing vehicles.

In addition or alternatively, it may advantageously be provided that the performance of the pattern recognition comprises a decomposition of at least one change signal into its frequency components, in particular by Fast Fourier Transformation (FFT). In this way, it can be easily and efficiently determined whether a frequency component corresponding to a reference frequency is contained in the respective change signal. The decomposition of a change signal into its frequency components also makes it possible to subsequently provide a change signal that has been rectified for selected frequency components. By way of example, for the creation of a rectified change signal, the frequency components that correspond to reference frequencies can be neglected.

With reference to the present invention, it is, moreover, conceivable that the performance of the pattern recognition involves a correlation of at least one change signal with a reference oscillation or alternatively a reference oscillation signal, wherein the reference oscillation or the reference oscillation signal has the reference frequency. This allows a conclusion to be drawn about the similarity of the respective signals and thus about the occurrence of the reference frequency within the change signal.

It may be advantageously provided that the adjustment of the operation of the anti-theft alarm system comprises at least one of the following: adjustment of the change reference value in the event of a positive recognition result in such a way that the sensitivity of the anti-theft alarm system is reduced, in particular by the sensor device and/or a control unit; and/or adjustment of the change reference value in the event of a negative recognition result in such a way that the sensitivity of the anti-theft alarm system is increased, in particular to an initial sensitivity, or maintained, in particular by the sensor device and/or a control unit.

In this context, initial sensitivity should be understood to be the sensitivity that exists when no movement of objects within the vehicle interior has been detected. To reduce the sensitivity of the anti-theft alarm system, the change limit value can preferably be raised or alternatively increased. This means that greater changes in the runtime components are required to trigger an alarm. To increase the sensitivity of the anti-theft alarm system, the change limit value can preferably be lowered. This means that only minor changes in the runtime components are necessary to trigger an alarm. In particular, if the recognition result is negative, the change reference value can be changed back to its initial value, if it was previously increased, in order to restore the initial sensitivity of the anti-theft alarm system. If a negative recognition result is provided repeatedly, the change reference value corresponding to the initial sensitivity can then preferably be retained.

The adjustment of the change reference value can take place as a function of the number of runtime components for which a positive recognition result was provided and/or as a function of the number of detected reference frequencies. In particular, the sensitivity of the anti-theft alarm system can be increasingly reduced as the number of runtime components for which a positive recognition result has been provided increases and/or as the number of detected reference frequencies increases. Combined movements of the vehicle as well as a plurality of interfering objects in the vehicle interior can accordingly thereby be taken into account.

In addition or alternatively, with reference to the present invention, it may be provided that the adjustment of the operation of the anti-theft alarm system comprises the following: reduction of a weighting and/or neglecting at least one runtime component for which a positive recognition result has been provided during the determination of the change value, in particular by the sensor device and/or a control unit.

In particular, it may be provided that, during the determination of the change value, the runtime components for which a positive recognition result has been provided are weighted with a weighting factor less than 1, wherein the remaining runtime components are weighted with a weighting factor of 1. In an equivalent manner, the weighting of remaining runtime components can also be increased and the weighting of runtime components for which a positive recognition result has been provided can be left unchanged. In this case, an additional adjustment of the change limit value may be useful. Alternatively, those runtime components for which a positive recognition result has been provided can be completely disregarded when determining the change value. By the reduction of the weighting or alternatively the disregard of the relevant runtime components, the sensitivity of the anti-theft alarm system with regard to individual runtime components can be reduced and false alarms can be avoided.

Preferably, in the context of the invention, it may be provided that the adjustment of the operation of the anti-theft alarm system comprises: neglect of the frequency components corresponding to at least one reference frequency in the determination of the change value, in particular by the sensor device and/or a control unit.

In other words, it may be provided that those change components in the runtime components which are caused by the movement sequences of interfering objects in the vehicle interior corresponding to the reference frequencies are neglected in a targeted manner. In this way, a sensitivity of the anti-theft alarm system in the relevant runtime components can still be maintained notwithstanding a movement of interfering objects in the vehicle interior.

The neglect of the frequency components or alternative change components corresponding to at least one reference signal in the changes of one or a plurality of runtime components can be realized in such a way, for example, that a provision of at least one rectified change signal takes place, wherein at least one frequency component corresponding to a reference frequency has been removed from the underlying change signal. This can preferably take place by a decomposition of the change signal into its frequency components (for example, by FFT) and new generation of the rectified change signal while neglecting the corresponding frequency components.

A rectified change signal thereby describes the temporal course of the changes of a runtime component across a plurality of impulse responses, without there, however, being any interfering frequency components contained therein. If this is performed for all affected runtime components, rectified changes of the individual impulse responses can in turn be provided on the basis of the rectified change signals. On the basis of a rectified change of an impulse response, a change value can in turn be determined in the manner described, in which, however, the frequency components corresponding to one or a plurality of reference frequencies or alternatively to the changes attributable to these frequency components are no longer contained.

In addition or alternatively, it may be provided that the determination of changes in the runtime components comprises: filtering of the changes in the runtime components, in particular by means of a high-pass filter, in particular by the sensor device and/or a control unit.

Interference effects or alternatively noise effects can hereby be removed and a higher-quality signal can be provided.

It may preferably be provided that the reception of an impulse response comprises a demodulation and/or sampling of at least one wave signal arriving at the sensor device. It may preferably be provided that the sampling of a wave signal takes place with a frequency of between 0.5 GHz and 2 GHz, particularly preferably with a frequency of 1 GHz.

Each sampling thereby corresponds to a runtime component in the impulse response. If a sampling is performed at 1 GHz, which is to say, at time intervals of 1 ns, neighboring runtime components are spaced apart by a runtime difference of 1 ns. Assuming that electromagnetic waves propagate at the speed of light, which can be approximated as 300,000,000 m/s, this runtime difference can be converted into a distance to the object by which the output signal was reflected. A runtime of 1 ns corresponds to a run length of the signal of 30 cm. Due to the distance traveled by the signal to the object and the return path of the reflected signal to the sensor device, this corresponds to a distance of 15 cm between the object and the sensor device.

According to a second aspect, the present invention relates to an anti-theft alarm system for a vehicle, comprising at least one sensor device for monitoring a vehicle interior of the vehicle, wherein the anti-theft alarm system is formed to be operated according to a method according to the first aspect of the present invention. In this respect, with reference to the anti-theft alarm system, the same advantages are offered as those already described with reference to a method according to the first aspect of the present invention.

In the context of the invention, it may be provided that the anti-theft alarm system comprises a plurality of sensor devices for monitoring the vehicle interior of the vehicle. In particular, at least two, at least three, at least four, or more than four sensor devices may be provided.

A preferred further development of the present invention may consist in at least one sensor device being formed as a UWB sensor (UWB, ultra-wideband) or alternatively comprising at least one UWB sensor. The advantage that the function of the anti-theft alarm system can be implemented by means of sensors which are already present in a plurality of vehicles or alternatively can be used for other vehicle applications is hereby achieved. In this manner, UWB sensors are used in particular to locate a key or another ID provider, such as a mobile phone, in the interior of the vehicle in order to implement access control or alternatively usage control, in particular a keyless go system, in the vehicle. Such a vehicle system can be correspondingly implemented making use of the sensor devices provided in the anti-theft alarm system. The overall sensor technology required for a vehicle can thus be reduced, which decreases the complexity of the vehicle as well as the manufacturing costs.

For the transmission of an electromagnetic output signal and/or for the reception of an impulse response to the electromagnetic output signal, it may be provided that at least one sensor device comprises at least one antenna. It may be provided that at least two separate antennas are formed or alternatively used for transmission and reception. Alternatively, it may be provided that both transmission and reception are carried out by means of only one antenna.

In the context of the invention, it may, moreover, be provided that at least one sensor device is formed to transmit the electromagnetic output signal in a recurring manner, in particular at equidistant temporal intervals, or alternatively that the output signal is transmitted in a recurring manner, in particular at equidistant temporal intervals. In particular, the electromagnetic output signal may be transmitted, for example, with a frequency between 1 Hz and 50 Hz, in particular with a frequency between 5 Hz and 25 Hz, preferably with a frequency of at least or precisely 10 Hz. In a manner corresponding to the temporally recurring transmission of the output signal, the reception of impulse responses may also occur in a temporally recurring manner.

It may preferably be provided that the anti-theft alarm system comprises a sensor unit for acquisition of an external frequency imparted on the vehicle. Alternatively, it may be provided that the sensor unit is provided on the vehicle side or alternatively is encompassed by the vehicle. A sensor unit may in particular be designed as an inertial measurement unit (IMU). In this way, accelerations and movement sequences of the vehicle can be acquired and a corresponding external frequency can be determined or alternatively provided. At least one sensor unit preferably comprises at least one acceleration sensor, in particular designed as a microelectromechanical sensor (MEMS sensor).

An anti-theft alarm system may preferably comprise at least one control unit. The control unit may preferably be configured to control, at least in part, the execution of a method according to the first aspect of the present invention.

At least one control unit and/or sensor device may comprise means for data processing. In particular, the means for data processing may comprise at least one processor and/or at least one working memory and/or at least one, in particular non-volatile, data memory.

At least one control unit may preferably, at least temporarily, be in signal communication with at least one sensor device and/or at least one alarm and/or at least one sensor unit means or alternatively be capable of being brought into such communication. In this manner, for example, signals of the sensor device/sensor unit can be transmitted to the control unit, and be processed by the control unit, and, if necessary, an alarm means can be activated by the control unit. The processes described can also be implemented directly by a sensor device. Alternatively, it may be provided that at least one control unit is integrated into a sensor device or alternatively is comprised therein.

According to a third aspect, the present invention relates to a vehicle comprising an anti-theft alarm system according to the second aspect of the present invention. In particular, at least one sensor device of the anti-theft alarm system may be formed as a UWB sensor. In addition or alternatively, it may be provided that at least one sensor device of the anti-theft alarm system may be provided for the implementation of a vehicle system for access control or usage control, in particular a keyless go system, in the vehicle. Through the use of electromagnetic sensors, the integration of an anti-theft alarm system into a vehicle can be implemented more cost-effectively and efficiently, inasmuch as the use of dedicated sensor devices can be avoided. The vehicle may preferably be formed as a car or alternatively as a passenger car or as a commercial vehicle, in particular as a truck.

It is, moreover, preferably conceivable that at least one sensor device of the anti-theft alarm system is arranged in or alternatively on a headliner of the vehicle. This results in the advantage that the sensor device cannot be accidentally covered by objects placed in the vehicle interior.

In the context of the invention, it may preferably be provided that an anti-theft alarm system and/or a vehicle comprises at least one alarm means. At least one alarm means may be formed as a visual alarm means or alternatively for the issuance of a visual alarm signal. A visual alarm means may, for example, be formed as a light source of the vehicle, in particular as a headlight, a turn signal, a taillight, interior lighting, or the like. The activation of an alarm means, in particular a visual alarm means, may, for example, comprise the activation of a hazard warning light system of the vehicle. In addition or alternatively, in the context of the invention, at least one alarm means may be formed as an acoustic alarm means or alternatively for the issuance of an acoustic warning signal. An acoustic alarm means may, for example, be formed as a horn of the vehicle or as a loudspeaker for emitting an acoustic warning signal.

According to a fourth aspect, the present invention relates to a computer program product, wherein the computer program product comprises commands that cause an anti-theft alarm system according to the second aspect of the present invention to execute a method according to the first aspect of the present invention. In this respect, with reference to the computer program product according to the invention, the same advantages are offered as those described with reference to the method according to the invention and/or to the anti-theft alarm system according to the invention and/or to the vehicle according to the invention.

According to a fifth aspect, the present invention relates to a computer-readable storage medium, wherein a computer program product according to the fourth aspect of the present invention is stored on the computer-readable storage medium. In this respect, in reference to the computer-readable storage medium according to the invention, the same advantages are offered as those described with reference to a method according to the invention and/or to an anti-theft alarm system according to the invention and/or to a vehicle according to the invention and/or to a computer program product according to the invention.

According to a sixth aspect, the present invention relates to a data carrier signal, wherein the data carrier signal transmits a computer program product according to the fourth aspect of the present invention. In this respect, with reference to the data carrier signal according to the invention, the same advantages are offered as those described with reference to a method according to the invention and/or to an anti-theft alarm system according to the invention and/or to a vehicle according to the invention and/or to a computer program product according to the invention and/or to a computer-readable storage medium according to the invention.

Further advantages, features, and details of the invention are apparent from the following description, in which several embodiment examples of the invention are described in detail drawing reference to the drawings. The features mentioned in the claims and in the description may thereby be essential to the invention individually or in any combination.

### BRIEF DESCRIPTION OF THE DRAWINGS

The invention is elucidated in more detail below with reference to the accompanying drawings. Wherein:

FIG. 1 shows a schematic view of a method;

FIG. 2 shows a schematic view of an anti-theft alarm system;

FIG. 3 shows a schematic view of a vehicle;

FIG. 4 shows a schematic view of changes in impulse responses over time; and

FIG. 5 shows a schematic view of a change signal of a runtime component.

### DETAILED DESCRIPTION OF THE CURRENT EMBODIMENTS

In the figures, identical reference symbols are used for the same technical features, even in different embodiment examples.

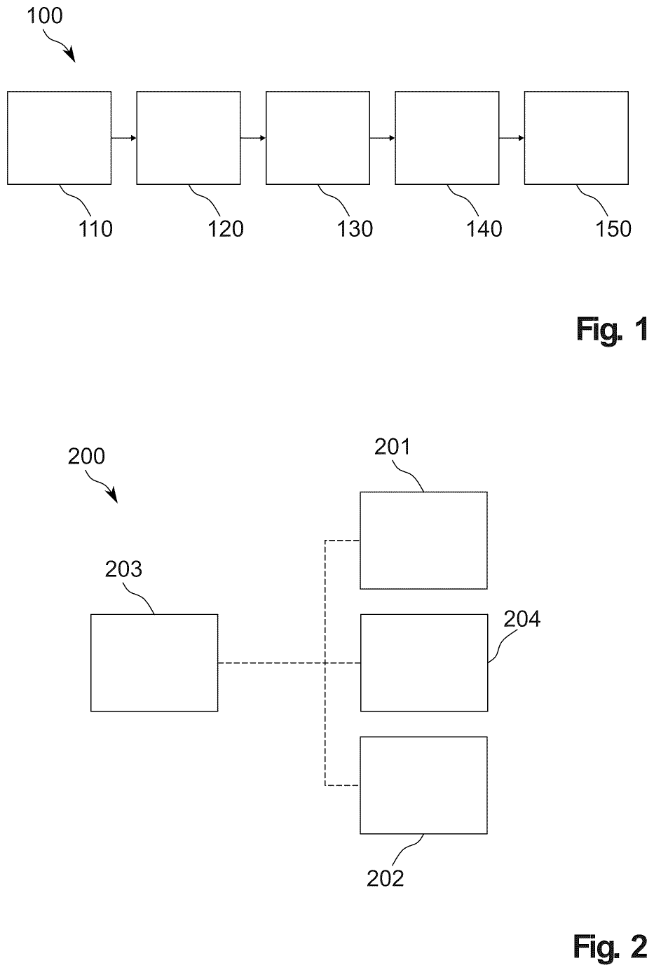

FIG. 1 shows a schematic view of a method 100 for operating an anti-theft alarm system 200 for a vehicle 300, comprising at least one sensor device 201 for monitoring a vehicle interior 301 of the vehicle 300 as well as at least one alarm means 202, wherein the method 100 comprises: transmission 110 of an electromagnetic output signal by the sensor device 201; reception 120 of an impulse response to the output signal by the sensor device 201, wherein the impulse response comprises a plurality of runtime components LK, wherein each runtime component LK is characteristic of a specific signal runtime; comparison 130 of the impulse response with a reference impulse response and determination of changes D of the runtime component LK relative to the reference impulse response; determination 140 of a change value as a function of the changes in at least a portion of the runtime component LK, in particular by aggregating the changes in at least a portion of the runtime component LK; and activation 150 of at least one alarm means when the change value reaches or exceeds a predetermined change reference value.

FIG. 2, moreover, shows a schematic view of an anti-theft alarm system 200 for a vehicle 300, comprising at least one sensor device 201 for monitoring a vehicle interior 301 of the vehicle 300. The anti-theft alarm system 200 is formed to be operated according to a method 100 according to the first aspect of the present invention.

The anti-theft alarm system moreover comprises a control unit 203 for controlling the anti-theft alarm system 200 as well as an alarm means 202 that can be activated or alternatively deactivated by the control unit 203. The anti-theft alarm system 200 moreover comprises a sensor unit 204 for acquisition of an external frequency imparted on the vehicle 300. Alternatively or additionally, at least one alarm means 202 and/or at least one sensor unit 204 can also be implemented on the vehicle side

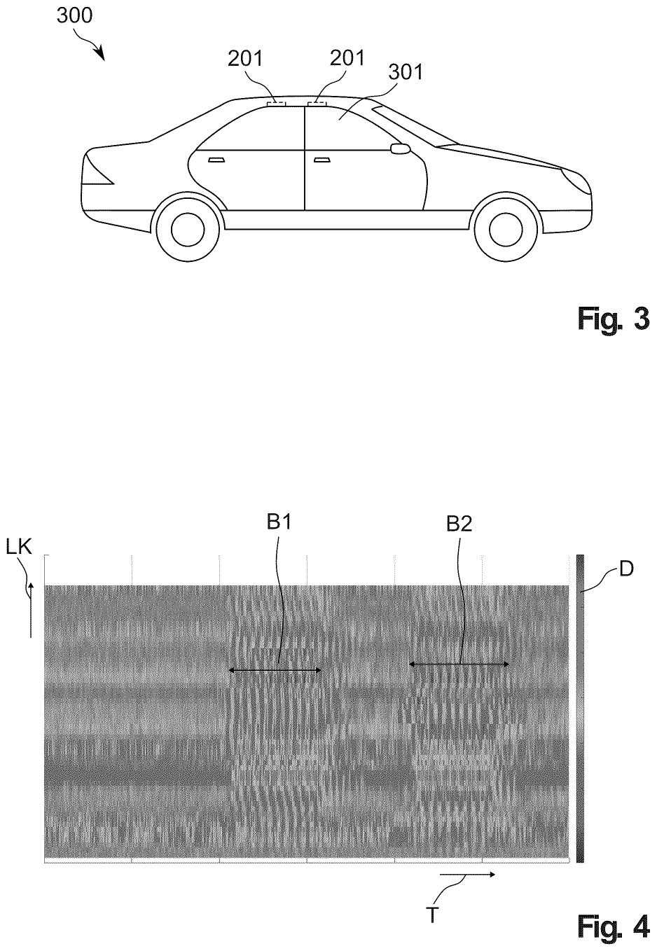

FIG. 3, moreover, shows a schematic view of a vehicle 300 comprising an anti-theft alarm system 200 according to the second aspect of the present invention. Two sensor devices 201 of the anti-theft alarm system 200 are shown here for monitoring a vehicle interior 301 of the vehicle 300. The sensor devices 201 are arranged in or alternatively on a headliner of the vehicle 300.

FIG. 4 shows a schematic view of changes D in impulse responses relative to a reference impulse response, plotted over time T, wherein the impulse responses were received by a sensor device 201 in response to electromagnetic output signals transmitted in temporal succession. Different impulse responses or alternatively their respective changes D relative to the reference impulse response are plotted over time T. The changes D of the impulse responses are composed of the changes of the runtime components LK comprised by the respective impulse responses.

It can be seen from FIG. 4 that there is a first area B1 and a second area B2 in which periodic changes are discernible across a series of impulse responses for at least a portion of the runtime components. In this case, these changes were generated by an oscillatory motion imparted on the vehicle 300, wherein the frequency of these periodic changes corresponds to a natural frequency of the mass-spring system of the vehicle 300.

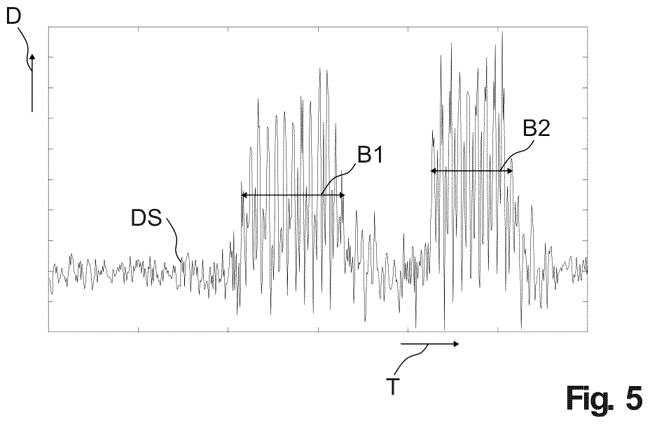

FIG. 5 shows a schematic course of a change signal DS, which was extracted based on the data shown in FIG. 4 and characterizes the course of changes D of a runtime component LK over several impulse responses or alternatively over time T.

Knowing the natural frequency of the mass-spring system of the vehicle 300, a pattern recognition can be performed for the change signal DS shown in FIG. 5 in order to define those frequency components in the change signal DS that correspond to the natural frequency as a reference frequency.

On this basis, the operation of the anti-theft alarm system 200, in particular the sensitivity of the anti-theft alarm system, can then be adjusted.

The preceding description of the embodiments describes the present invention exclusively in the context of examples. Of course, individual features of the embodiments can be freely combined with each other, provided that this is technically sensible, without departing from the scope of the present invention.

### LIST OF REFERENCE NUMBERS

100 Method
110 Transmission
120 Reception
130 Comparison
140 Determination
150 Activation
200 Anti-theft alarm system
201 Sensor device
202 Alarm means
203 Control unit
204 Sensor unit
300 Vehicle
301 Vehicle interior
LK Runtime component
B1 First area
B2 Second area
D Change
T Time

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for operating an anti-theft alarm system for a vehicle, the vehicle including a sensor device for monitoring an interior of the vehicle, wherein the method comprises:
transmitting an electromagnetic output signal by the sensor device;
receiving an impulse response to the output signal by the sensor device, wherein the impulse response comprises a plurality of runtime components, wherein each runtime component is characteristic of a specific signal runtime;
comparing the impulse response with a reference impulse response and determining changes of the runtime components relative to the reference impulse response;
determining a change value as a function of the changes in at least a portion of the runtime components by aggregating the changes in at least a portion of the runtime components; and
activating an alarm when the change value reaches or exceeds a predetermined change reference value.

2. The method of claim 1, further comprising:
providing a change signal of a runtime component, wherein the change signal characterizes a temporal course of the changes of the runtime component;
performing a pattern recognition for a reference frequency in the change signal for the detection of frequency components in the change signal that correspond to the reference frequency, and providing a recognition result; and
adjusting an operation of the anti-theft alarm system as a function of the recognition result.

3. The method of claim 1, wherein:
the reference frequency is a natural frequency of the vehicle; or
the reference frequency is an external frequency imparted on the vehicle.

4. The method of claim 3, wherein providing the change signal only occurs when a change limit value reaches or exceeds a predetermined limit value.

5. The method of claim 2, wherein performing the pattern recognition comprises decomposing a change signal into its frequency components by Fast Fourier Transformation or comprises correlating a change signal with a reference oscillation, wherein the reference oscillation has the reference frequency.

6. The method according to claim 2, wherein adjusting operation of the anti-theft alarm system comprises one of the following:
adjusting the change reference value in the event of a positive recognition result, such that a sensitivity of the anti-theft system is reduced; or
adjusting the change reference value in the event of a negative recognition result, such that a sensitivity of the anti-theft system is increased.

7. The method according to claim 2, wherein adjusting operation of the anti-theft alarm system comprises the following:
neglecting a runtime component for which a positive recognition result has been provided during the determination of the change value.

8. The method according to claim 2, wherein adjusting operation of the anti-theft alarm system comprises:
neglecting the frequency components corresponding to a reference frequency during the determination of the change value.

9. An anti-theft alarm system for a vehicle, the vehicle including a sensor device for monitoring a vehicle interior, wherein the anti-theft alarm system is configured to operate in accordance with the method of claim 1.

10. The anti-theft alarm system of claim 9, wherein the sensor device is an ultra-wideband sensor.

11. The anti-theft alarm system of claim 10, further including a sensor unit for acquiring an external frequency imparted on the vehicle.

12. A vehicle comprising the anti-theft alarm system of claim 9.

13. A computer-program product comprising commands that cause an anti-theft alarm system to perform the method according to claim 1.

14. A computer-readable storage medium on which the computer-program product of claim 13 is stored.
